(19) United States
(12) Patent Application Publication
(10) Pub. No.: US 2026/0152183 A1
(43) Pub. Date: Jun. 4, 2026

(54) CONTROL DEVICE FOR VEHICLE

(71) Applicant: TOYOTA JIDOSHA KABUSHIKI KAISHA, Toyota-shi (JP)

(72) Inventor: Hideki KUBONOYA, Toyota-shi (JP)

(73) Assignee: TOYOTA JIDOSHA KABUSHIKI KAISHA, Toyota-shi (JP)

(21) Appl. No.: 19/283,809

(22) Filed: Jul. 29, 2025

(30) Foreign Application Priority Data
Nov. 29, 2024 (JP) 2024-209129

(51) Int. Cl. B60W 30/18; B60K 1/02; B60W 40/105

(52) U.S. Cl. CPC B60W 30/18172; B60K 1/02; B60W 40/105; B60W 2510/18; B60W 2520/06; B60W 2520/26; B60W 2520/28; B60W 2520/30; B60W 2530/201

(57) ABSTRACT

When the vehicle is traveling in a state where the difference between the tire load rates is not larger than a predetermined load rate difference, learning control is performed. Therefore, the learning control can be performed in a wider range of the driving force as compared with a case where the learning control is performed during traveling in a state where the tire slip rate is small and a range of the driving force is minute. Even when the vehicle is traveling in a state where the difference between the tire load rates is not larger than the predetermined load rate difference, the learning control is not performed when the vehicle travels in the tire nonlinear region. Thus, an increase can be prevented or reduced in the learning error due to an increase in the change amount of the tire slip rate during traveling in the tire nonlinear region.

### CROSS-REFERENCE TO RELATED APPLICATION

This application claims priority to Japanese Patent Application No. 2024-209129 filed on Nov. 29, 2024. The disclosure of the above-identified application, including the specification, drawings, and claims, is incorporated by reference herein in its entirety.

### BACKGROUND

### 1. Technical Field

The present disclosure relates to a control device for a vehicle including right and left front wheels and right and left rear wheels.

### 2. Description of Related Art

A control device for a vehicle including right and left front wheels and right and left rear wheels, and a power source that generates power that is a driving force of the wheels is well known. An example of the control device is a straight traveling state determination device for a vehicle described in Japanese Unexamined Patent Application Publication No. 2005-7933 (JP 2005-7933 A). JP 2005-7933 A discloses that when determination is made that the vehicle is normally traveling in a straight-traveling state, a learned value is obtained based on a difference in wheel speeds caused by a variation in tire diameters, and the difference in wheel speeds is corrected by the learned value.

### SUMMARY

Here, in order to reduce a learning error, in a case where determination is made that a tire slip rate of each of the wheels is minute, in addition to a straight traveling determination, learning control of correcting, by learning, the difference in the wheel speeds caused by a difference in the tire diameters in the wheels is considered to be performed,. However, in a case where determination is made that the tire slip rate is minute, a range of the driving force that is learnable is limited to a range of a minute driving force, and thus a frequency of performing the learning control may be reduced.

The present disclosure has been made in view of the above circumstances, and an object thereof is to provide a control device for a vehicle that is capable of increasing an opportunity for learning control while an increase in a learning error is reduced.

A summary of a first disclosure is
(a) a control device for a vehicle including right and left front wheels and right and left rear wheels, and a power source configured to generate power that is a driving force of the wheels, in which
(b) the control device includes a learning controller configured to perform learning control of correcting, by learning, a difference in wheel speeds that is caused by a difference in tire diameters in the wheels, and
(c) the learning controller is configured to perform the learning control in a case where determination is made that traveling is being performed in a state in which a difference in tire load rates is not larger than a predetermined load rate difference, the tire load rate being a value of the driving force with respect to a ground contact load at the wheels, and that the traveling is being performed in a tire linear region in which a value of a change amount of a tire slip rate with respect to a change amount of the tire load rate is small, and configured not to perform the learning control in a case where determination is made that the traveling is being performed in a state in which the difference in the tire load rates exceeds the predetermined load rate difference or in a case where determination is made that the traveling is being performed in a tire nonlinear region in which the value of the change amount of the tire slip rate with respect to the change amount of the tire load rate is large.

According to the first disclosure, in a case where the traveling is being performed in a state in which the difference in the tire load rates is not larger than the predetermined load rate difference, the learning control is performed. As a result, it is possible to perform the learning control in a wider range of the driving force as compared with a case where the learning control is performed during the traveling in a state in which a range of the driving force is minute and in which the tire slip rate is minute. Even when the traveling is being performed in a state in which the difference in the tire load rates is not larger than the predetermined load rate difference, in a case where the traveling is not being performed in the tire linear region, that is, in a case where the traveling is being performed in a tire nonlinear region, the learning control is not performed. As a result, it is possible to prevent or reduce an increase in a learning error due to an increase in the change amount of the tire slip rate during traveling in the tire nonlinear region where the tire slip rate is large. Therefore, it is possible to increase an opportunity for performing the learning control while the increase in the learning error is reduced.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a schematic configuration of a vehicle to which the disclosure is applied, and is a diagram illustrating main parts of a control function and a control system for various controls in the vehicle;

FIG. 2 is a diagram illustrating a range of the driving force for which the learning control is performed;

FIG. 3 is a diagram illustrating a tire linear region and a tire nonlinear region;

FIG. 4 is a flowchart illustrating a main part of a control operation of the electronic control unit, and is a flowchart illustrating a control operation for increasing an opportunity for performing the learning control while suppressing an increase in a learning error;

FIG. 5 is a flowchart illustrating a control operation for performing the load rate deviation small determination, and is a subroutine corresponding to S10 in the flowchart of FIG. 4; and

FIG. 6 is a flowchart illustrating a control operation for performing the tire linear region determination, and is a subroutine corresponding to S20 in the flowchart of FIG. 4.

### DETAILED DESCRIPTION OF EMBODIMENTS

Hereinafter, embodiments of the present disclosure will be described in detail with reference to the drawings.

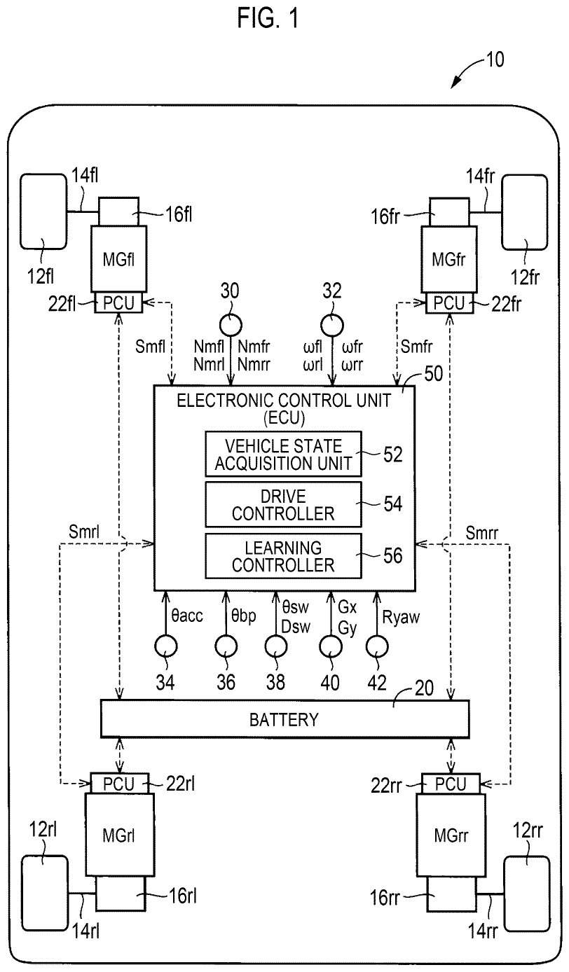

FIG. 1 is a diagram illustrating a schematic configuration of a vehicle 10 to which the present disclosure is applied. FIG. 1 is a diagram illustrating main parts of a control function and a control system for various controls in the vehicle 10. In FIG. 1, the vehicle 10 includes right and left front and rear wheels 12, and electric motors MG provided independently for each wheel 12. The electric motor MG is a power source of the present disclosure that generates power that is the driving force Fx of the wheels 12. The driving force Fx of the wheel 12 is a force in the wheel 12, that is, a frictional force of a ground point in the wheel 12, that is, a road surface grip force. The wheels 12 include a left front wheel 12fl, a right front wheel 12fr, a left rear wheel 12rl, and a right rear wheel 12rr. The electric motor MG includes a left front electric motor MGfl, a right front electric motor MGfr, a left rear electric motor MGrl, and a right rear electric motor MGrr. The “front and rear” is the front and rear in the front-rear direction of the vehicle 10, and the “right and left” is the right and left with respect to the traveling direction of the vehicle 10.

The vehicle 10 is a four-wheel drive vehicle in which a driving force distribution of wheels 12 is adjustable. Since the vehicle 10 is a vehicle having four right and left front and rear wheels, the vehicle 10 is also a four-wheel drive vehicle. In the present embodiment, all-wheel drive (AWD) and four-wheel drive (4WD) are synonymous. The vehicle 10 can travel by two-wheel drive (=2WD) control (2WD state is also the same) that drives solely front wheels or solely rear wheels among the wheels 12 in addition to traveling by all-wheel drive (AWD) control (AWD state is also the same) that drives all the wheels 12.

The vehicle 10 includes a drive shaft 14, a gear mechanism 16, a battery 20, and a power control unit 22. The drive shaft 14 and the gear mechanism 16 are members that constitute a part of a power transmission device that transmits power from the electric motor MG to the wheels 12. The gear mechanism 16 is, for example, a reduction gear. The battery 20 is a rechargeable and dischargeable direct current power source, and is a high-voltage battery for driving. The battery 20 is electrically connected to the power control unit 22. The power control unit 22 includes, for example, an inverter. The power control unit 22 is electrically connected to the electric motor MG. The power control unit 22 is a power control unit (PCU) that controls electric power transmitted and received between the battery 20 and the electric motor MG. The electric power is also synonymous with electric energy unless otherwise specified. The power is also a synonym for driving force, torque, and force when not particularly distinguished.

The electric motor MG is a known rotary electric machine, and is a so-called motor generator. Regarding the electric motor MG, the power control unit 22 is controlled by an electronic control unit 50 described below, and thus an electric motor torque Tm which is a torque of the electric motor MG is controlled.

The drive shaft 14 includes a left front drive shaft 14fl, a right front drive shaft 14fr, a left rear drive shaft 14rl, and a right rear drive shaft 14rr. The gear mechanism 16 includes a left front gear mechanism 16fl, a right front gear mechanism 16fr, a left rear gear mechanism 16rl, and a right rear gear mechanism 16rr. One side of the left front drive shaft 14fl is connected to the left front electric motor MGfl via the left front gear mechanism 16fl, and the other side of the left front drive shaft 14fl is connected to the left front wheel 12fl. The connection relationship in the right front drive shaft 14fr and the right front gear mechanism 16fr and the connection relationship in the left rear drive shaft 14rl and the left rear gear mechanism 16rl are the same. The connection relationship between the right rear drive shaft 14rr and the right rear gear mechanism 16rr is also the same.

The power control unit 22 includes a left front PCU 22fl, a right front PCU 22fr, a left rear PCU 22rl, and a right rear PCU 22rr. The left front PCU 22fl converts the direct current electric power from the battery 20 into alternating current electric power and supplies the alternating current electric power to the left front electric motor MGfl, or converts the alternating current electric power generated by the left front electric motor MGfl by the regenerative brake into the direct current electric power and supplies the direct current electric power to the battery 20. The functions of the right front PCU 22fr and the right front electric motor MGfr, the left rear PCU 22rl and the left rear electric motor MGrl, and the right rear PCU 22rr and the right rear electric motor MGrr are also the same.

The vehicle 10 is a vehicle capable of independently controlling the change amount of the driving force Fx of each of the right and left front and rear wheels, and is a four-wheel independent drive type battery electric vehicle, that is, a battery electric vehicle (BEV). In the vehicle 10, the driving force can be distributed to the right and left front and rear wheels according to the traveling state.

The vehicle 10 further includes an electronic control unit 50 (see “ECU” in the figure) as a controller. The electronic control unit 50 includes, for example, a so-called microcomputer including a CPU, a RAM, a ROM, an input/output interface, and the like. The CPU executes various controls of the vehicle 10 by executing signal processing in accordance with a program stored in the ROM in advance while using a temporary storage function of, for example, the RAM. The electronic control unit 50 is a control device of the present disclosure.

Various signals and the like based on detection values by various sensors and the like provided in the vehicle 10 are respectively supplied to the electronic control unit 50. Various sensors include, for example, an electric motor rotation sensor 30, a wheel speed sensor 32, an accelerator operation amount sensor 34, a brake sensor 36, a steering sensor 38, a G sensor 40, and a yaw rate sensor 42. Various signals and the like are, for example, an electric motor rotation speed Nm, a wheel speed ω, an accelerator operation amount θacc, a brake operation amount θbp, a steering angle θsw, a steering direction Dsw, a front-rear acceleration Gx, a right-left acceleration Gy, and a yaw rate Ryaw. The electric motor rotation sensor 30 includes a left front electric motor rotation sensor 30fl, a right front electric motor rotation sensor 30fr, a left rear electric motor rotation sensor 30rl, and a right rear electric motor rotation sensor 30rr. The wheel speed sensor 32 includes a left front wheel speed sensor 32fl, a right front wheel speed sensor 32fr, a left rear wheel speed sensor 32rl, and a right rear wheel speed sensor 32rr.

The electric motor rotation speed Nm is the rotation speed of the electric motor MG. The electric motor rotation speed Nm includes a left front electric motor rotation speed Nmfl, a right front electric motor rotation speed Nmfr, a left rear electric motor rotation speed Nmrl, and a right rear electric motor rotation speed Nmrr. The wheel speed ω is the rotation speed of the wheel 12. The wheel speed ω includes a left front wheel speed ωfl, a right front wheel speed ωfr, a left rear wheel speed ωrl, and a right rear wheel speed ωrr. The accelerator operation amount θacc is a signal corresponding to an acceleration request amount representing the magnitude of the acceleration operation of the driver, and is an accelerator operation amount by the driver. The brake operation amount θbp is a signal representing a state in which a brake pedal for operating the wheel brake is operated by the driver, and is a signal representing a magnitude of a depression operation of the brake pedal. The wheel brake is a mechanical brake that is provided in each of the wheels 12 and is operated by, for example, hydraulic pressure, that is, a friction brake such as a disc brake or a drum brake. The steering angle θsw is a steering angle of a steering wheel. The steering direction Dsw is a steering direction of the steering wheel. The front-rear acceleration Gx is an acceleration in the front-rear direction of the vehicle 10. The right-left acceleration Gy is an acceleration in the right-left direction of the vehicle 10. The yaw rate Ryaw is a rotation angular velocity of the vehicle 10 around a vertical axis.

The electronic control unit 50 outputs various command signals or the like (for example, the electric motor control command signal Sm) to each device or the like (for example, the power control unit 22) provided in the vehicle 10. The electric motor control command signal Sm is a torque command value for controlling the electric motor torque Tm. The electric motor control command signal Sm includes a left front electric motor control command signal Smfl, a right front electric motor control command signal Smfr, a left rear electric motor control command signal Smrl, and a right rear electric motor control command signal Smrr. The left front electric motor control command signal Smfl is a torque command value for controlling the left front electric motor torque Tmfl which is the torque of the left front electric motor MGfl, and is output to the left front PCU 22fl. The same applies to the right front electric motor control command signal Smfr, the left rear electric motor control command signal Smrl, and the right rear electric motor control command signal Smrr.

The electronic control unit 50 includes a vehicle state acquisition unit 52, a drive controller 54, and a learning controller 56 in order to realize various controls in the vehicle 10.

The vehicle state acquisition unit 52 acquires an estimated value of the vehicle body speed Vx of the vehicle 10 based on the wheel speed ω. For example, the vehicle state acquisition unit 52 acquires the minimum value or the second slowest value of the wheel speeds ω (ωfl, ωfr, ωrl, ωrr) as the estimated value of the vehicle body speed Vx. When slip occurs in the wheels 12, the estimated value of the vehicle body speed Vx becomes higher than the actual value of the vehicle body speed Vx, and the lifting of the vehicle body speed Vx occurs. The vehicle state acquisition unit 52 restricts the rising gradient of the estimated value of the vehicle body speed Vx with the speed obtained by integrating the front-rear acceleration Gx such that the rise of the vehicle body speed Vx is suppressed. Alternatively, the vehicle state acquisition unit 52 may acquire, as the estimated value of the vehicle body speed Vx, the vehicle body speed Vx used by a known traction control function or an ABS function, for example. In the following, in the present embodiment, the vehicle body speed Vx simply represented indicates an estimated value of the vehicle body speed Vx, that is, the estimated vehicle body speed Vx.

The drive controller 54 calculates the request drive torque Tdrvdem for the vehicle 10 based on, for example, the accelerator operation amount θacc and the vehicle body speed Vx. The request driving torque Tdrvdem is a request value of the driving torque Tdrv which is a torque in the wheels 12. The drive controller 54 sets the torque distribution ratio of the right and left front and rear wheels based on a plurality of driving force-related values, such as an accelerator operation amount θacc, a vehicle body speed Vx, a steering angle θsw, a steering direction Dsw, a front-rear acceleration Gx, a right-left acceleration Gy, and a yaw rate Ryaw. The drive controller 54 calculates a request left front wheel torque Tdrvfldem and a request right front wheel torque Tdrvfrdem based on the request drive torque Tdrvdem and the torque distribution ratio. Similarly, the requested left rear wheel torque Tdrvrldem and the requested right rear wheel torque Tdrvrrdem are calculated. The requested left front wheel torque Tdrvfldem is a request value of the left front wheel drive torque Tdrvfl. The requested right front wheel torque Tdrvfrdem is a request value of the right front wheel drive torque Tdrvfr. The requested left rear wheel torque Tdrvrldem is a request value of the left rear wheel drive torque Tdrvrl. The requested right rear wheel torque Tdrvrrdem is a request value of the right rear wheel drive torque Tdrvrr. The drive torque Tdrv is a value obtained by adding the left front wheel drive torque Tdrvfl, the right front wheel drive torque Tdrvfr, the left rear wheel drive torque Tdrvrl, and the right rear wheel drive torque Tdrvrr.

The drive controller 54 outputs a left front electric motor control command signal Smfl to the left front PCU 22fl to realize the requested left front wheel torque Tdrvfldem. The drive controller 54 outputs the right front electric motor control command signal Smfr to the right front PCU 22fr such that the requested right front wheel torque Tdrvfrdem is realized. The drive controller 54 outputs the left rear electric motor control command signal Smrl to the left rear PCU 22rl to realize the requested left rear wheel torque Tdrvrldem. The drive controller 54 outputs the right rear electric motor control command signal Smrr to the right rear PCU 22rr to realize the requested right rear wheel torque Tdrvrrdem.

The vehicle state acquisition unit 52 acquires an estimated value of the left front wheel drive torque Tdrvfl based on the left front electric motor control command signal Smfl output by the drive controller 54. The vehicle state acquisition unit 52 acquires an estimated value of the right front wheel drive torque Tdrvfr based on the right front electric motor control command signal Smfr output from the drive controller 54. The vehicle state acquisition unit 52 acquires an estimated value of the left rear wheel drive torque Tdrvrl based on the left rear electric motor control command signal Smrl output from the drive controller 54. The vehicle state acquisition unit 52 acquires an estimated value of the right rear wheel drive torque Tdrvrr based on the right rear electric motor control command signal Smrr output by the drive controller 54. In the following, in the present embodiment, the left front wheel drive torque Tdrvfl simply represented indicates the estimated value of the left front wheel drive torque Tdrvfl. The same applies to the right front wheel drive torque Tdrvfr, the left rear wheel drive torque Tdrvrl, and the right rear wheel drive torque Tdrvrr.

The vehicle state acquisition unit 52 acquires an estimated value of the ground contact load Fz on the wheels 12. For example, the vehicle state acquisition unit 52 calculates the dynamic ground contact load on each of the wheels 12 based on the static ground contact load on each of the wheels 12 determined in advance from the specifications of the vehicle 10 and the estimation of the load movement in the front-rear and right-left directions. The vehicle state acquisition unit 52 acquires the dynamic ground contact load as an estimated value of the ground contact load Fz at each of the wheels 12. The vehicle state acquisition unit 52 estimates the load movement in the front-rear and right-left directions based on, for example, the front-rear acceleration Gx, the right-left acceleration Gy, the drive torque Tdrv in each of the wheels 12. Hereinafter, in the present embodiment, the ground contact load Fz simply represented indicates an estimated value of the ground contact load Fz. The ground contact load Fz includes a left front wheel ground contact load Fzfl, a right front wheel ground contact load Fzfr, a left rear wheel ground contact load Fzrl, and a right rear wheel ground contact load Fzrr.

The vehicle state acquisition unit 52 determines whether the wheel brake is operated based on the brake operation amount θbp. For example, the vehicle state acquisition unit 52 determines whether the wheel brake is in the brake off state in which the wheel brake is not operated, based on the brake operation amount θbp.

The vehicle state acquisition unit 52 determines whether the vehicle 10 is traveling straight based on the steering angle θsw, the yaw rate Ryaw, and the like. The vehicle state acquisition unit 52 sets the straight traveling determination flag to “on” in a case where determination is made that the vehicle 10 is traveling straight. The vehicle state acquisition unit 52 sets the straight traveling determination flag to “off” when determination is made that the vehicle 10 is not traveling straight.

The learning controller 56 performs learning control CNlrn of correcting a difference in wheel speeds ω caused by a difference in tire diameters in the wheels 12 by learning. The difference in the tire diameter or the wheel speed ω is, for example, a variation between four right and left front and rear wheels.

In the learning control CNlrn, the learning controller 56 first calculates a rotation angle θ (=Σω) of each of the wheels 12 by integrating each wheel speed ω of the wheels 12. The rotation angle θ includes a left front wheel rotation angle θfl (=Σωfl), a right front wheel rotation angle θfr (=Σωfr), a left rear wheel rotation angle θrl (=Σωrl), and a right rear wheel rotation angle θrr (=Σωrr). Next, the learning controller 56 calculates an average rotation angle θave (=(θfl+θfr+θrl+θrr)/4) that is an average value of the rotation angles θ in the wheels 12. Next, the learning controller 56 determines whether the average rotation angle θave is equal to or greater than a learning completion threshold value. The learning completion threshold value is, for example, a predetermined threshold value for determining that the wheels 12 have rotated by the amount needed to execute the learning control CNlrn. When the learning controller 56 determines that the average rotation angle θave is equal to or greater than the learning completion threshold value, the learning controller 56 calculates a value (=θave/θ) obtained by dividing the average rotation angle θave in the wheel 12 by the rotation angle θ of each of the wheels 12 as the correction coefficient K of each of the wheels 12. The correction coefficient K includes a left front wheel correction coefficient Kfl (=θave/θfl), a right front wheel correction coefficient Kfr (=θave/θfr), a left rear wheel correction coefficient Krl (=θave/θrl), and a right rear wheel correction coefficient Krr (=θave/θrr). Next, the learning controller 56 multiplies each wheel speed ω of the wheels 12 by the corresponding correction coefficient K to calculate the corrected wheel speed ωc (ωfl×Kfl, ωfr×Kfr, ωrl×Krl, ωrr×Krr) of each wheel 12. The learning controller 56 performs the learning control CNlrn by performing the above-described calculation.

Here, in order to reduce the learning error, it is conceivable that the learning control CNlrn is executed during traveling in a state in which the straight traveling determination flag is “on” and the slip of the wheels 12 does not occur or is small. That is, it is conceivable that the learning control CNlrn is performed during traveling in a range in which the absolute value of the tire slip rate S in the wheels 12 is small. However, during traveling in which the tire slip rate S is small, the range of the drivable driving force Fx that can be learned is limited to the range of the small driving force Fx. Therefore, there is a concern that the frequency of performing the learning control CNlrn is reduced.

The learning controller 56 calculates a value of an increase in wheel speed ω with respect to the vehicle body speed Vx as each tire slip rate S of the wheels 12 (value =(ω−Vx)/Vx). The tire slip rate S includes a left front wheel slip rate Sfl (=(ωfl−Vx)/Vx) and a right front wheel slip rate Sfr (=(ωfr−Vx)/Vx). Further, the tire slip rate S includes a left rear wheel slip rate Srl (=(ωrl−Vx)/Vx) and a right rear wheel slip rate Srr (=(ωrr−Vx)/Vx).

The learning controller 56 calculates a tire load rate μx (=Fx/Fz) which is a value of the driving force Fx with respect to the ground contact load Fz in the wheels 12. The tire load rate μx includes a left front tire load rate μxfl (=Fxfl/Fzfl), a right front tire load rate μxfr (=Fxfr/Fzfr), a left rear tire load rate μxrl (=Fxrl/Fzrl), and a right rear tire load rate μxrr (=Fxrr/Fzrr). As shown in the following equation (1), the wheel 12 is accelerated by a difference between the drive torque Tdrv and the product of the driving force Fx and the tire radius R. In the following equation (1), “I” is an inertia applied to the wheels 12 of the electric motor MG, the gear mechanism 16, the drive shaft 14, the tire weight, and the like, and is a predetermined value. The learning controller 56 calculates the driving force Fx by using the following equation (1). As the tire radius R, a design value is used.

I×(dω/dt)=Tdrv−Fx×R (1)

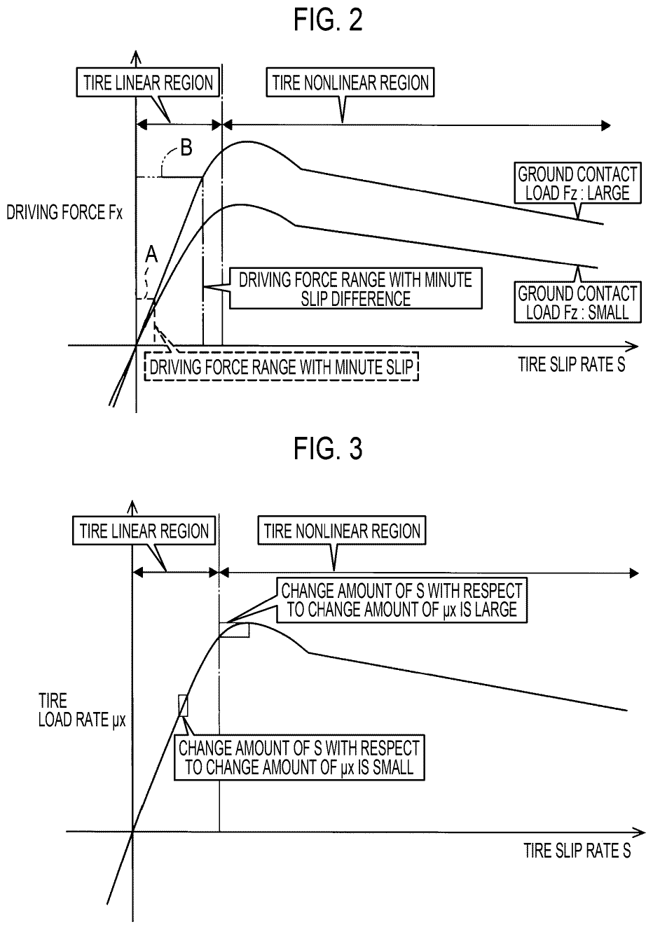

FIG. 2 is a diagram illustrating a range of the driving force Fx that performs the learning control CNlrn. FIG. 2 shows an example of a relationship between the tire slip rate S and the driving force Fx due to a difference in the ground contact load Fz. In FIG. 2, the learning range of the comparative example shown by the broken line A is a range of the driving force Fx in which the absolute value of the tire slip rate S, that is, the micro slip, is small. The learning range of the present embodiment shown by the two-dot chain line B is a range of the driving force Fx in which the difference between the slip differences of the four wheels, that is, the tire slip rate S is minute. The fact that the difference of the tire slip rates S is minute means that the tire slip rates S of the four wheels are substantially the same. When the driving force Fx in which the tire load rate μx of the four wheels is substantially equal, the four-wheel tire slip rate S is substantially equal. Therefore, the learning control CNlrn is permitted when the tire load rates μx of the four wheels are substantially equal to each other, and the execution frequency of the learning control CNlrn is increased. As the distribution of the driving force Fx proportional to the ground contact load Fz is closer to the even distribution, the tire load rate μx of the four wheels is equalized. When the driving force Fx proportional to the ground contact load Fz is distributed, the execution frequency of the learning control CNlrn can be significantly increased. In the learning range of the present embodiment, the range of the driving force Fx is widened as compared with the range of the driving force Fx in which the absolute value of the tire slip rate S is in a minute state. However, since the tire slip rate S may increase, the learning control CNlrn is prohibited during traveling in the tire nonlinear region.

FIG. 3 is a diagram illustrating a tire linear region and a tire nonlinear region. FIG. 3 shows an example of a relationship between the tire slip rate S and the tire load rate μx. In FIG. 3, the tire linear region is a region in which a value of a change amount of the tire slip rate S with respect to a change amount of the tire load rate μx is small. The tire nonlinear region is a region in which a value of a change amount of the tire slip rate S with respect to a change amount of the tire load rate μx is large. Therefore, during traveling in the tire nonlinear region, the learning control CNlrn is prohibited.

The learning controller 56 executes the learning control CNlrn in a case where the difference in the tire load rate μx in the wheels 12 is equal to or smaller than a predetermined load rate difference Δμxf and the determination is made that the vehicle is traveling and the determination is made that the vehicle is traveling in the tire linear region. On the other hand, the learning controller 56 does not execute the learning control CNlrn in a case where determination is made that the vehicle is traveling in a state in which the difference between the tire load rate μx in the wheels 12 exceeds the predetermined load rate difference Δμxf, or determination is made that the vehicle is traveling in the tire nonlinear region. The predetermined load rate difference Δμxf is, for example, a predetermined threshold value for determining that the tire load rates μx of the four wheels are substantially equal to each other.

The learning controller 56 calculates an average load rate μxave (=(μxfl+μxfr+μxrl+μxrr)/4) that is an average value of the tire load rates μx in the wheels 12. The learning controller 56 calculates a load rate deviation Δμx (=μx−μxave) that is a difference between the average load rate μxave in the wheels 12 and each tire load rate μx of the wheels 12. The load rate deviation Δμx includes a left front wheel load rate deviation Δμxfl (=μxfl−μxave) and a right front wheel load rate deviation Δμxfr (=μxfr−μxave). The load rate deviation Δμx further includes a left rear wheel load rate deviation Δμxrl(=μxrl−μxave) and a right rear wheel load rate deviation Δμxrr (=μxrr−μxave). The learning controller 56 calculates a maximum load rate deviation Δμxmax (=max(|four wheels Δμx|)) that is a maximum value among absolute values of load rate deviations Δμx in the wheels 12 as a difference in tire load rate μx in the wheels 12.

The learning controller 56 determines whether traveling is performed in a state in which the difference between the tire load rate μx in the wheels 12 is equal to or less than the predetermined load rate difference Δμxf based on whether the maximum load rate deviation Δμxmax is equal to or less than the predetermined load rate difference Δμxf. The learning controller 56 determines whether a maximum driving force Fxmax (=max(|four wheels Fx|)) that is a maximum value among absolute values of driving forces Fx in the wheels 12 is equal to or less than a predetermined driving force Fxf. The predetermined driving force Fxf is, for example, a predetermined threshold value for determining that the driving force Fx is in a minute range.

When the learning controller 56 determines that the maximum load rate deviation Δμxmax is equal to or less than the predetermined load rate difference Δμxf or determines that the maximum driving force Fxmax is equal to or less than the predetermined driving force Fxf, the learning controller 56 turns on the load rate deviation small determination flag. When the learning controller 56 determines that the maximum load rate deviation Δμxmax exceeds the predetermined load rate difference Δμxf and determines that the maximum driving force Fxmax exceeds the predetermined driving force Fxf, the learning controller 56 sets the load rate deviation small determination flag to “off”.

The driving force Fx is used to calculate the tire load rate μx. Therefore, when the wheel brake is actuated, there is a concern that the learnable area in the learning control CNlrn cannot be appropriately determined. The learning controller 56 does not execute the learning control CNlrn in a case where the vehicle state acquisition unit 52 determines that the vehicle 10 is not traveling straight or determines that the wheel brake is operated.

The learning controller 56 determines whether the determination by the vehicle state acquisition unit 52 is in the brake-off state. When the learning controller 56 determines that the brake is not in the off state, the load rate deviation small determination flag is set to “off”.

In the tire nonlinear region where the value of the change amount of the tire slip rate S with respect to the change amount of the tire load rate μx is large, the change amount of the wheel acceleration dω/dt with respect to the change in the drive torque Tdrv is increased (see equation (1)). In the tire nonlinear region, the tire slip rate S in the wheel 12 is increased. Alternatively, in the tire nonlinear region, the difference in the wheel speed ω in the wheels 12 is increased. Alternatively, in the tire nonlinear region, the difference in the wheel acceleration dω/dt in the wheel 12 is increased.

The tire slip rate S in the wheel 12 may be equal to or less than a predetermined slip rate Sf, a difference in wheel speed ω in the wheel 12 may be equal to or less than a predetermined speed difference Δωf, and a difference in wheel acceleration dω/dt in the wheel 12 may be equal to or less than a predetermined acceleration difference Δdωf. In this case, the learning controller 56 determines that the vehicle is traveling in the tire linear region. The tire slip rate S in the wheel 12 may exceed a predetermined slip rate Sf, or a difference in wheel speed ω in the wheel 12 may exceed a predetermined speed difference Δωf, or a difference in wheel acceleration dω/dt in the wheel 12 may exceed a predetermined acceleration difference Δdωf. In this case, the learning controller 56 determines that the vehicle is traveling in the tire nonlinear region. The predetermined slip rate Sf, the predetermined speed difference Δωf, and the predetermined acceleration difference Δdωf are, respectively, a predetermined threshold value, for example, for dividing a tire linear region and a tire nonlinear region.

The learning controller 56 determines whether the tire slip rate S in the wheels 12 is equal to or less than the predetermined slip rate Sf based on whether the maximum slip rate Smax (=max (|four wheels S|)) is equal to or less than the predetermined slip rate Sf. The maximum slip rate Smax (=max (|four wheels S|)) is the maximum value of the absolute values of the tire slip rates S in the wheels 12.

The learning controller 56 calculates a speed difference Δω (=|max(four wheels ω)−min(four wheels ω)|) that is an absolute value of a difference between a maximum value and a minimum value of the wheel speed ω in the wheels 12 as a difference in the wheel speed ω in the wheels 12. The learning controller 56 calculates an acceleration difference Δdω (=|max(4-wheel dω/dt)−min(4-wheel dω/dt)|) as a difference in wheel acceleration dω/dt in the wheels 12. The acceleration difference Δdω is an absolute value of a difference between a maximum value and a minimum value of the wheel acceleration dω/dt in the wheel 12.

The learning controller 56 determines whether the speed difference Δω is equal to or less than a predetermined speed difference Δωf. The learning controller 56 determines whether the acceleration difference Δdω is equal to or less than a predetermined acceleration difference Δdωf.

The learning controller 56 determines that the speed difference Δω is equal to or less than a predetermined speed difference Δωf, the acceleration difference Δdω is equal to or less than a predetermined acceleration difference Δdωf, and the maximum slip rate Smax is equal to or less than a predetermined slip rate Sf. In this case, the learning controller 56 sets the tire linear region determination flag to “on”. The learning controller 56 may determine that the speed difference Δω exceeds a predetermined speed difference Δωf. Alternatively, the learning controller 56 may determine that the acceleration difference Δdω exceeds the predetermined acceleration difference Δdωf. Alternatively, the learning controller 56 may determine that the maximum slip rate Smax exceeds the predetermined slip rate Sf. In these cases, the learning controller 56 sets the tire linear region determination flag to “off”.

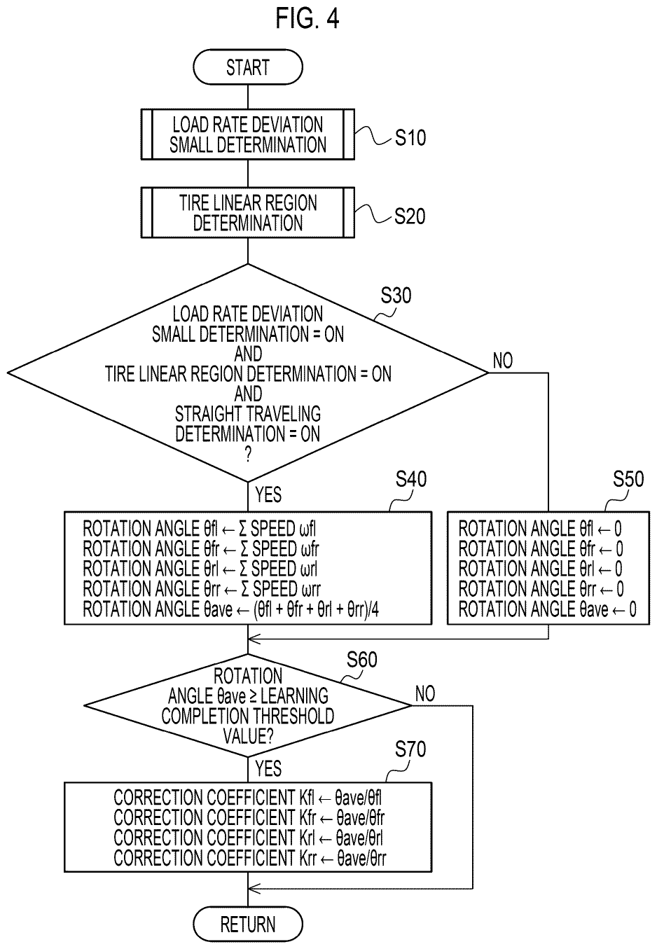

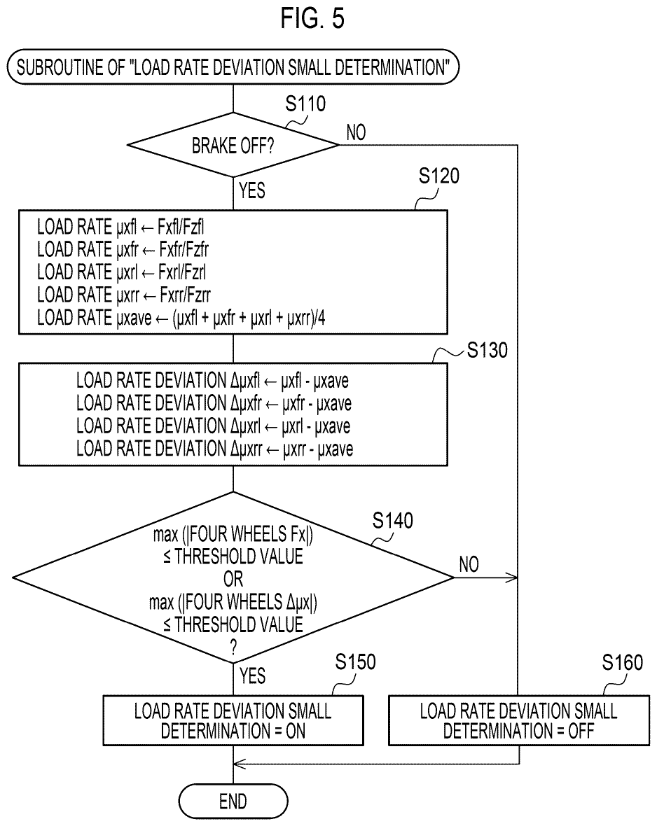

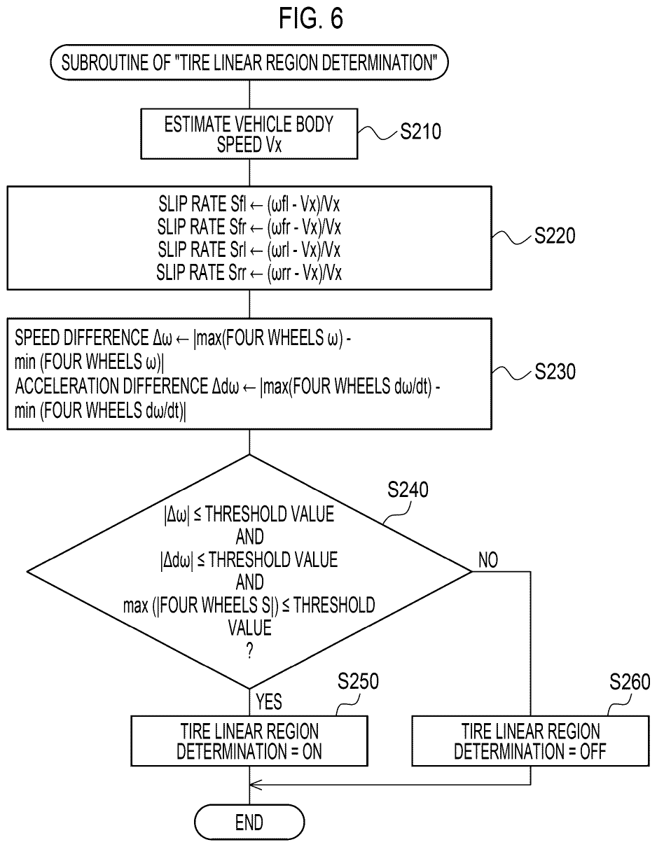

FIG. 4 is a flowchart illustrating a main part of a control operation of the electronic control unit 50, and is a flowchart illustrating a control operation for increasing an opportunity for performing the learning control CNlrn while suppressing an increase in the learning error, and is repeatedly executed, for example. FIG. 5 is a flowchart illustrating a control operation for performing the load rate deviation small determination. The flowchart of FIG. 5 shows a subroutine corresponding to S10 in the flowchart of FIG. 4. FIG. 6 is a flowchart illustrating a control operation for performing the tire linear region determination, and is a subroutine corresponding to S20 in the flowchart of FIG. 4.

In FIG. 4, each step of the flowchart corresponds to the function of the learning controller 56. First, in step (hereinafter, step is omitted) S10, the load rate deviation small determination is performed, and in step S20, the tire linear region determination is performed.

In FIG. 5, the load rate deviation small determination in S10 is performed. First, in S110, the determination is made whether the determination by the vehicle state acquisition unit 52 is in the brake-off state. When the determination in S110 is affirmative, in S120, each tire load rate μx (μxfl, μxfr, μxrl, μxrr) of the wheels 12 and an average load rate μxave are calculated. Next, in S130, the load rate deviation Δμx (Δμxfl, Δμxfr, Δμxrl, Δμxrr) of each of the wheels 12 is calculated. Next, in S140, determination is made whether the maximum driving force Fxmax (=max (|4-wheel Fx|)) is equal to or less than the predetermined driving force Fxf, or whether the maximum load rate deviation Δμxmax (=max (|4-wheel Δμx|)) is equal to or less than the predetermined load rate difference Δμxf. When the determination in S140 is affirmative, in S150, the load rate deviation small determination flag is set to “on”, and the present routine is terminated. When the determination in S110 is negative, or when the determination in S140 is negative, in S160, the load rate deviation small determination flag is set to “off”, and the present routine is terminated.

In FIG. 6, the tire linear region determination in S20 is performed. First, in S210, the vehicle body speed Vx estimated by the vehicle state acquisition unit 52 is acquired. Next, in S220, the tire slip rate S (Sfl, Sfr, Srl, Srr) of each of the wheels 12 is calculated. Next, in S230, the speed difference Δω and the acceleration difference Δdω are calculated. Next, in S240, determination is made whether the speed difference Δω is equal to or less than the predetermined speed difference Δωf, the acceleration difference Δdω is equal to or less than the predetermined acceleration difference Δdωf, and the maximum slip rate Smax (=max(|four wheels S|)) is equal to or less than the predetermined slip rate Sf. When the determination in S240 is affirmative, in S250, the tire linear region determination flag is turned on, and the present routine is terminated. When the determination in S240 is negative, in S260, the tire linear region determination flag is set to “off”, and the present routine is terminated.

The description returns to FIG. 4. In S30 following S10 and S20, determination is made whether the load rate deviation small determination flag is “on”, the tire linear region determination flag is “on”, and the straight traveling determination flag determined by the vehicle state acquisition unit 52 is “on”. When the determination in S30 is affirmative, in S40, each rotation angle θ (θfl, θfr, θrl, θrr) of each of the wheels 12 and the average rotation angle θave are calculated. When the determination in S30 is negative, in S50, each of the rotation angle θ and the average rotation angle θave is reset to zero. As a result, the learning control CNlrn is not substantially performed. Subsequently to the S40 or the S50, in S60, determination is made whether the average rotation angle θave is equal to or greater than the learning completion threshold value. When the determination in S60 is negative, the present routine is terminated. When the determination in S60 is affirmative, in S70, the correction coefficient K (Kfl, Kfr, Krl, Krr) of each of the wheels 12 is calculated, and the present routine is terminated. The correction coefficient K is used to calculate the corrected wheel speed ωc of each of the wheels 12.

As described above, according to the present embodiment, the learning control CNlrn is performed in a case where the vehicle is traveling in a state in which the difference of the tire load rate μx is equal to or smaller than the predetermined load rate difference Δμxf. As a result, it is possible to perform the learning control CNlrn in a wider range of the driving force Fx as compared with a case where the learning control CNlrn is performed during traveling in a state in which the tire slip rate S is small and which is a range of the minute driving force Fx. Even when the difference in tire load rate μx is equal to or smaller than the predetermined load rate difference Δμxf during traveling, the learning control CNlrn is not performed in a case where the vehicle is not traveling in the tire linear region, that is, in a case where the vehicle is traveling in the tire nonlinear region. As a result, it is possible to prevent or suppress an increase in the learning error due to an increase in the change amount of the tire slip rate S during traveling in the tire nonlinear region where the tire slip rate S is large. Therefore, the opportunity for performing the learning control CNlrn can be increased while the increase in the learning error is suppressed.

In addition, according to the present embodiment, a value of an increase in the wheel speed ω with respect to the vehicle body speed Vx is calculated as the tire slip rate S. The determination unit determines that the vehicle is traveling in the tire linear region in a case where the tire slip rate S is equal to or less than a predetermined slip rate Sf, a difference between the wheel speeds ω is equal to or less than a predetermined speed difference Δωf, and a difference between the wheel accelerations dω/dt is equal to or less than a predetermined acceleration difference Δdωf. As a result, even in a case where there is an estimation error of the vehicle body speed Vx, the difference in the wheel speed ω or the difference in the wheel acceleration dω/dt can be used to suppress the learning control CNlrn from being performed during traveling in the actual tire nonlinear region.

Further, according to the present embodiment, the maximum value of the absolute value of the load rate deviation Δμx is calculated as the difference of the tire load rate μx. As a result, determination is appropriately made as to whether the vehicle is traveling in a state in which the difference in the tire load rate μx is equal to or smaller than the predetermined load rate difference Δμxf.

In addition, according to the present embodiment, in a case where the determination is made that the vehicle does not travel straight or the determination is made that the wheel brake is operated, the learning control CNlrn is not performed. As a result, the learning control CNlrn is not performed during traveling in which the learning error is likely to increase.

In addition, according to the present embodiment, the rotation angle θ obtained by integrating the wheel speed ω is calculated. Then, as the correction coefficient K, a value obtained by dividing the average rotation angle θave by the rotation angle θ is calculated. Further, the learning control CNlrn is performed by multiplying the wheel speed ω by the correction coefficient K to calculate the wheel speed ωc after correction. As a result, the wheel speed ω is appropriately corrected by the learning control CNlrn.

Although the embodiments of the present disclosure have been described in detail based on the drawings, the present disclosure is also applicable to other aspects.

For example, in the above-described embodiments, the vehicle is not limited to the four-wheel independent drive type BEV. For example, the vehicle may be a vehicle of a type in which the power of the power source is distributed to each of four wheels. Alternatively, the power source may use an engine in addition to or instead of the electric motor. That is, the present disclosure can be applied to an all-wheel drive vehicle including right and left front wheels and right and left rear wheels, and a power source that generates power as a driving force of the wheels.

It should be noted that the above is merely one embodiment, and the present disclosure can be carried out in various modified and improved aspects based on the knowledge of those skilled in the art.

What is claimed is:

1. A control device for a vehicle including right and left front wheels and right and left rear wheels, and a power source configured to generate power that is a driving force of the wheels, the control device comprising a learning controller configured to perform learning control of correcting, by learning, a difference in wheel speeds that is caused by a difference in tire diameters in the wheels, wherein the learning controller is configured to perform the learning control in a case where determination is made that traveling is being performed in a state in which a difference in tire load rates is not larger than a predetermined load rate difference, the tire load rate being a value of the driving force with respect to a ground contact load at the wheels, and that the traveling is being performed in a tire linear region in which a value of a change amount of a tire slip rate with respect to a change amount of the tire load rate is small, and configured not to perform the learning control in a case where determination is made that the traveling is being performed in a state in which the difference in the tire load rates exceeds the predetermined load rate difference or in a case where determination is made that the traveling is being performed in a tire nonlinear region in which the value of the change amount of the tire slip rate with respect to the change amount of the tire load rate is large.

2. The control device according to claim 1, wherein:
the learning controller is configured to calculate a value of an increase in the wheel speed with respect to a vehicle body speed that is estimated, as the tire slip rate; and
the learning controller is configured to determine that the traveling is being performed in the tire linear region in a case where the tire slip rate at the wheels is not larger than a predetermined slip rate, the difference in the wheel speeds of the wheels is not larger than a predetermined speed difference, and a difference in wheel acceleration of the wheels is not larger than a predetermined acceleration difference.

3. The control device according to claim 1, wherein the learning controller is configured to calculate, as the difference in the tire load rates, a maximum value among absolute values of differences between an average value of the tire load rates of the wheels and the tire load rates of the respective wheels.

4. The control device according to claim 1, wherein the learning controller is configured not to perform the learning control in a case where determination is made that straight traveling is not being performed or determination is made that a wheel brake is operated.

5. The control device according to claim 1, wherein the learning controller is configured to perform the learning control by calculating a rotation angle of each of the wheels, the rotation angle being obtained by integrating the wheel speed of each of the wheels, calculating, as a correction coefficient for each of the wheels, a value obtained by dividing an average value of rotation angles of the wheels by the rotation angle of each of the wheels, and calculating a corrected wheel speed of each of the wheels by multiplying the wheel speed of each of the wheels by the correction coefficient that corresponds.
